(19) United States
(12) Patent Application Publication
(10) Pub. No.: US 2017/0171552 A1
(43) Pub. Date: Jun. 15, 2017

(54) METHOD OF REAL-TIME TRANSCODING FOR INHERITANCE OF ENCODING INFORMATION AND ELECTRONIC APPARATUS FOR THE SAME

(71) Applicants: LE HOLDINGS (BEIJING) CO., LTD., Beijing (CN); LECLOUD COMPUTING CO., LTD., Beijing (CN)

(72) Inventor: Maosheng BAI, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/247,730

(22) Filed: Aug. 25, 2016

Related U.S. Application Data
(63) Continuation of application No. PCT/CN2016/088693, filed on Jul. 5, 2016.

(30) Foreign Application Priority Data
Dec. 14, 2015 (CN) 201510927461.8

(51) Int. Cl. H04N 19/40; H04N 19/51; H04N 19/59; H04N 19/176; H04N 19/70

(52) U.S. Cl. CPC H04N 19/40; H04N 19/176; H04N 19/70; H04N 19/59; H04N 19/51

(57) ABSTRACT

Embodiments of the disclosure provide a method of real-time transcoding for inheritance of encoding information and a device for the same. decoding an input code stream and obtaining a code stream information during process of decoding, wherein the code stream information comprises frame type and macroblock encoding information of a decoded frame; and predicting frame type and macroblock encoding information of the decoded frame corresponding to the input code stream according to the code stream information, and transcoding the input code stream. A 4K real-time transcoding featured with low cast, high quality and high efficiency is achieved.

### CROSS REFERENCE TO RELATED APPLICATIONS

This application is a continuation of International Application No. PCT/CN2016/088693, filed on Jul. 5, 2016, which is based upon and claims priority to Chinese Patent Application No. 201510927461.8, filed on Dec. 14, 2015, the entire contents of which are incorporated herein by reference.

### TECHNICAL FIELD

The present disclosure relates to a field of video, particular to a method for real-time transcoding for inheritance of encoding information and an electronic apparatus for the same.

### BACKGROUND

With the popularity of 4K televisions and the increase of domestic bandwidth, the demand of high quality live video has been increasing. The 4K television is the television which uses a screen having 4K resolution. The 4K resolution is a new standard for digital cinematography and digital content, and the name “4K resolution” is originated from a horizontal resolution of approximately 4000 pixels, and there are few differences according to different applications. The 4K resolution can provide at least a total of about 8.8 million pixels to achieve an image quality same as movie, which is almost four times more than 1080p resolution and four times finer and smoother than 1080p.

Of course, there are some costs when the television is improved to have 4K resolution. In the 4K display, the amount of data of each frame is up to 50 MB such that both the decoder and the editor are needed to have top-level configuration. The real-time transcoding for 4K images consumes a large amount of source in the decoder, the price of the decoder for 4K real-time transcoding is expensive, and it is unfavorable for functional expansion and cloud computing.

Therefore, with effectively reducing the complexity of encoding, a method of real-time transcoding for high quality video is needed urgently.

### SUMMARY

Embodiments of the disclosure provide a method of real-time transcoding for inheritance of encoding information, and the method is adapted to solve the problem that the conventional technique is inapplicable to 4K real-time transcoding in the clouds.

In first aspect, embodiments of the disclosure provide a method of real-time transcoding for inheritance of encoding information, including steps of:

decoding an input code stream and obtaining a code stream information during process of decoding, wherein the code stream information comprises frame type and macroblock encoding information of a decoding frame; and

predicting frame type and macroblock encoding information of a transcoded frame corresponding to the input code stream according to the code stream information, and transcoding the input code stream.

In second aspect, embodiments of the disclosure provide a non-volatile computer storage medium. The computer storage medium stores computer-executable instructions, and the computer-executable instructions can carry out the method of real-time transcoding for inheritance of encoding information in any one of the embodiments.

In third aspect, embodiments of the disclosure provide an electronic apparatus for executing real-time transcoding for inheritance of encoding information, including:

at least one processor; and

a memory communicatively connected to the processor, wherein the memory is for storing one or more instructions executable by the processor, the processor is for calling the instructions stored in the memory to execute the method of real-time transcoding for inheritance of encoding information in any one of the embodiments.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a technique flow chart of an embodiment of the disclosure;

FIG. 2 is a technique flow chart of another embodiment of the disclosure;

FIG. 3 is a technique flow chart of another embodiment of the disclosure;

FIG. 4 is a technique flow chart of another embodiment of the disclosure;

FIG. 5 is a schematic view of a device of another embodiment of the disclosure; and

FIG. 6 is a schematic view of an electronic apparatus of another embodiment of the disclosure.

### DETAILED DESCRIPTION

The disclosure provides an idea to detect the noise intensity of the video automatically, and dynamically denoise the video according to the noise intensity of the video; by two layers of airspace denoising, the video is denoised while the low frequency image information in each frame of the video is maximally kept.

In a conventional configuration, a computer apparatus includes one or more central processing units (CPU), an input/output interface, a network interface and a memory.

The memory may include read only memory (ROM), random access memory (RAM) and/or nonvolatile memory, such as read only memory (ROM) and flash memory (flash RAM). The memory is an exemplary computer readable storage device.

The computer-readable medium includes a permanent and non-permanent, can be mobile and non-mobile media can be formed by any method or technology to realize the information storage. Information can be computer-readable instructions, data structures, program modules or other data. Examples of computer storage medium, including, but not limited to a phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, CD-ROM read-only memory (CD-ROM), digital versatile disc (DVD) or other optical storage, magnetic tape magnetism box type, magnetic tape magnetism magnetic disk storage or other magnetic storage device, or any other non-transmission medium, can be can be used to store the information of the computing device to access. In accordance with the definition herein, computer readable medium does not include non-temporary storage of computer-readable media (transitory media), if the modulated data signal and a carrier.

If the specification of the application and claims to refer to particular assembly of certain terms. The technicians of this field should be understood, may be hardware manufacturers use different terminology to refer to the same assembly. The specification and claim in order to distinguish the difference of the name of a mode of assembly, but with the difference of the function as the specific criteria. Throughout the specification and in the claims, “comprising” is an open terminology, therefore, should be explains “include but not limited to”. “Substantially” means that the error range can be received, the technical personnel in the field within a certain error range for solving the technical problems, the technical effect substantially achieved. Furthermore, the term “coupled” in this includes any direct and indirect electrical coupling means. Therefore, if a described in the text device is coupled between a 1st 2nd device, on behalf of the device can be directly electrically coupled to 1st and 2nd devices, or through other device or coupling means is indirectly electrically coupled to the 2nd device. The specification for the implementation of the subsequent description of the preferred embodiment, is however states described in order to explain the general principles of this application for the purpose, and is not used to limit the scope of this application. The scope of the application should be defined based on the claims.

It is further noted that the term “comprising”, “including” or any other variation thereof, are intended to cover a non-exclusive inclusion, such that a series of factors including the process, method, product or system includes not only those elements, but also include other elements not expressly listed or further comprising for such process, method, product or inherent in the system elements. In the absence of more restrictive, by the statement “includes a” defining elements, does not exclude the existence of additional identical elements in the process include the elements, methods, goods or system.

The embodiments of the disclosure are applicable to real-time transcoding, especially the transcoding for 4K.

### 1^{st} Embodiment

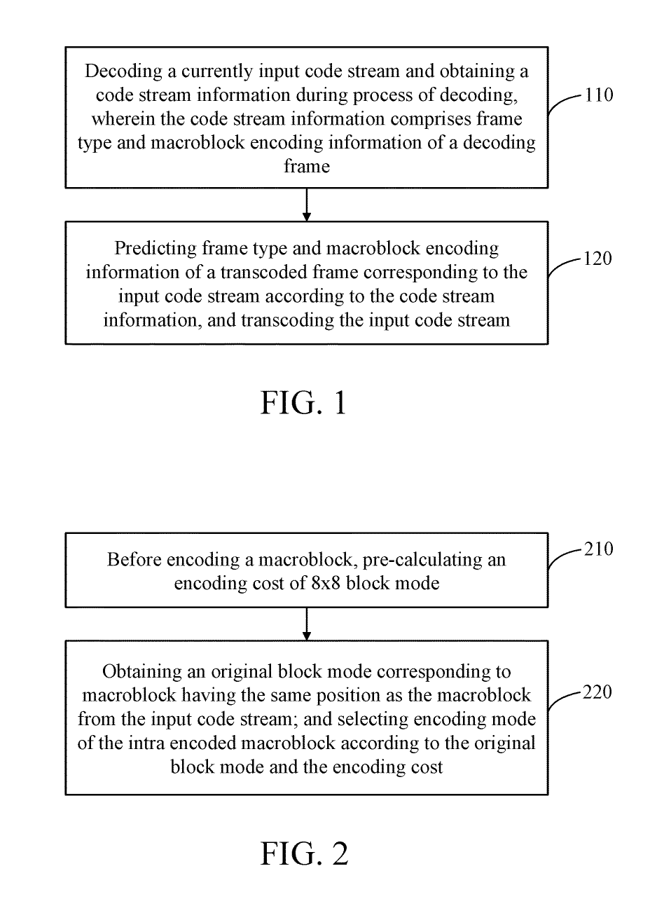

FIG. 1 is a technique flow chart of an embodiment of the disclosure. The first embodiment of the disclosure provides a method of real-time transcoding for inheritance of encoding information, and the method mainly includes two steps:

step 110: decoding a code stream which is currently input and obtaining a code stream information during process of decoding, wherein the code stream information comprises frame type and macroblock encoding information of a decoding frame;

when a transcoding system is working, the 4K code stream is decoded at first, and then the decoded video frame is encoded. The core of this embodiment of the disclosure is to obtain an original encoding information before the decoding frame is encoded, and the inheritance of encoding information is performed according to the original encoding information, such that the encoding information is able to be predicted for high encoding quality.

In this embodiment of the disclosure, the default encoding format is format is H.264 video encoding. The type frame of the input code stream includes the frame type comprises an intra predictive encoded frame (I-frame), a previous predictive encoded frame (P-frame) or a bidirectional predictive encoded frame (B-frame).

Data is transmitted in a small unit called frame on the Internet. The frame is constituted by plural different parts which have different functions. A single frame is a static image, and plural consecutive frames forms animation such as TV program.

In a compression, many algorithms are used to reduce bits of data, and the IPB is the most general one. An I-frame is an intra predictive encoded frame which belongs to intra frame compression. The I-frame can be decoded merely by the original frame information since the I frame includes complete image.

A P-frame is a previous predictive encoded frame belongs to inter frame encoding. The I-frame represents the difference between this frame and a previous frame. Residual data and predicted information by forward motion compensation are used to rebuild the current P-frame.

A B-frame is a bidirectional predictive encoded frame, that is, the B-frame records the difference among the original frame, the previous frame and the following frame. When the B-frame is decoded, both the previous frame and the following frame are needed, and residual data and predicted information by previous and following motion compensation are used to rebuild the current B-frame.

In this embodiment of the disclosure, the macroblock encoding information includes the encoding mode, the reference frame and the motion vector of each macroblock in the original input code stream, and the encoding information can be inherited by the following encoding step to achieve high efficient encoding prediction.

Step 120: predicting frame type and macroblock encoding information of a transcoded frame corresponding to the input code stream according to the code stream information, and transcoding the input code stream.

When H.264 is used as the video encoding format, the frame type corresponding to the input code stream is taken as the frame type of the transcoded frame, that is, the intra predictive encoded frame, the previous predictive encoded frame and the bidirectional predictive encoded frame.

The transcoding of the input code stream includes the transcoding of the intra predictive encoded frame, the previous predictive encoded frame and the bidirectional predictive encoded frame:

when encoding an intra encoded macroblock in the intra predictive encoded frame, pre-calculating an encoding cost of 8×8 block mode; obtaining an original block mode corresponding to one macroblock having the same position as the intra encoded macroblock in the intra predictive encoded frame from the input code stream; and selecting the encoding mode of the intra encoded macroblock according to the original block mode and the encoding cost.

when encoding the previous predictive encoded frame, obtaining an original block mode corresponding to one macroblock having the same position as encoded macroblock in the previous predictive encoded frame from the input code stream; obtaining a motion vector according to the motion estimation of the original block mode; and performing the motion compensation predictive encoding for the previous predictive encoded frame according to the motion vector.

when encoding the bidirectional predictive encoded frame, obtaining an original block mode corresponding to one macroblock having the same position as encoded macroblock in the bidirectional predictive encoded frame from the input code stream; and selecting the best encoding mode of the bidirectional predictive encoded frame according to the original block mode and B-DIRECT mode which is enabled by default.

It should be explained that the type of the repeated frame is marked as the previous predictive encoded frame if frame rate is changed during process of transcoding to cause a repeated frame, and using SKIP encoding mode to encode default macroblock in the repeated frame.

In the transcoding process of this embodiment, after the input code stream is decoded, the information of the input code stream is obtained, and this information can be used and inherited to achieve 4K real-time transcoding with high efficiency and high quality.

### 2^{nd} Embodiment

FIG. 2 is a technique flow chart of another embodiment of the disclosure. The second embodiment is a specific example for encoding the intra encoded macroblock in the intra predictive encoded frame according to the method of real-time transcoding for inheritance of encoding information. The I-frame is encoded by intra predictive mode. The block modes can be divided into I-16×16, I-8×8 and I-4×4. To ensure video quality, a traversal is generally performed to select the best mode, which severely increases the amount of time for encoding. However, the I-frame is the reference frame such that the first priority is to consider a better video quality.

Step 210: when encoding an intra encoded macroblock in the intra predictive encoded frame, pre-calculating an encoding cost of 8×8 block mode;

since I-8×8 is only defined in H.264-High-profile, some of the input code streams are not use this mode. I-8×8 is a compromised choice between I-16×16 and I-4×4 such that the encoding cost of I-8×8 block mode is pre-calculated when the encoded macroblock is encoded for ensuring better video quality;

step 220: obtaining an original block mode corresponding to one macroblock having the same position as the intra encoded macroblock in the intra predictive encoded frame from the input code stream.

When the original block mode is I-8×8, the current macroblock is encoded by I-8×8 original block mode;

when the original block mode is 16×16, the current macroblock is encoded by 16×16 original block mode;

when the original block mode is 4×4, the cost of I-4×4 is compared with the pre-calculated cost of I-8×8, and the one having less cost is used as the actual encoding mode.

In this embodiment of the disclosure, by determining the encoding mode of the coded macroblock having the same position as the current encoded macroblock from the input code stream, and pre-calculating the encoding cost of I-8×8 block mode, the best encoding mode for the I-frame can be rapidly selected to improve encoding efficiency and the encoded video quality.

### 3^{rd} Embodiment

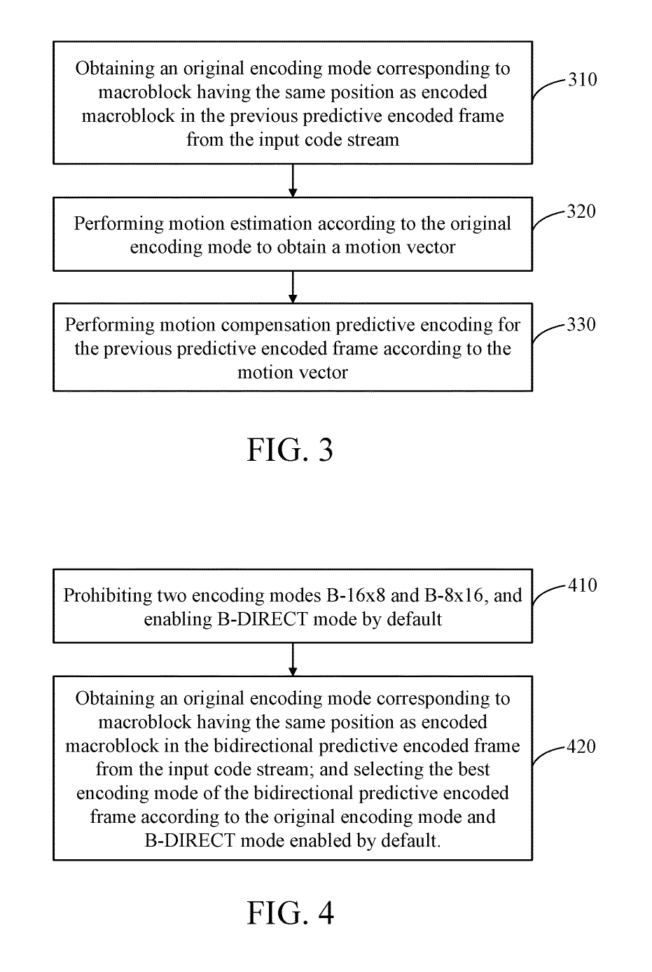

FIG. 3 is a technique flow chart of another embodiment of the disclosure. The third embodiment is a specific example for encoding the previous predictive encoded frame according to the method of real-time transcoding for inheritance of encoding information.

Since the P-frame uses a mixed mode including previous reference encoding and intra coding, the motion vector of the original input code stream corresponding to the position macroblock has high availability. Thus, in this embodiment of the disclosure, the motion vector of the input code stream is used as an initial reference point for estimating the following motions.

step 310: obtaining an original encoding mode corresponding to macroblock having the same position as encoded macroblock in the previous predictive encoded frame from the input code stream;

when the original encoding mode is intra encoded macroblock, the current coded macroblock is encoded by the encoding strategy having same as the intra encoding module in the I-frame.

When the original encoding mode is a macroblock of SKIP type (P-SKIP), it is determined that if the current encoded macroblock is suitable to be encoded by P-SKIP type, if it is suitable, the encoding mode of current encoded macroblock is marked as P-SKIP type.

When the original encoding mode is P-16×16, the current encoded macroblock only performs the mode decision between P-SKIP and P-16×16, and the one having less cost is used as the actual encoding mode.

When the original encoding mode is P-16×8, the current encoded macroblock only performs the mode decision between P-SKIP and P-16×8, and the one having less cost is used as the actual encoding mode.

When the original encoding mode is P-8×16, the current encoded macroblock only performs the mode decision between P-SKIP and P-8×16, and the one having less cost is used as the actual encoding mode.

When the original encoding mode is P-8×8, the current encoded macroblock only performs the mode decision between P-16×16 and P-8×8.

Step 320: obtaining a motion vector according to motion estimation of the original encoding mode;

In the inter frame predictive coding, since the scenery in motional images close to the frame correspond to each other. Thus, the motional image can be divided into several blocks or macroblocks, and try to find the position where each block or macroblock is located in the adjacent frame of image, and obtain a relative shift in the space between positions of the block and the frame of image. The obtained relative shift is the motion vector.

The motion vector and the error of prediction generated by motion matching are transmitted to a decoding end by quantification-transformation process. According to the position indicated by the motion vector at the decoding end, the block or macroblock corresponding to adjacent decoding frame of image is found, and the block or macroblock is added with the error of prediction to rebuild the current macroblock.

In this embodiment of the disclosure, when the original encoding mode is the macroblock of SKIP type (P-SKIP), a pair of coordinates MV (0^{,}0) is considered as an original point for searching another possible motion vector;

when the original encoding mode is P-16×16, P-16×8, P-8×16 or P-8×8, the position of the macroblock corresponding to the current encoded macroblock in the input code stream is considered as the original point for searching another possible motion vector.

Step 330: performing motion compensation predictive encoding for the previous predictive encoded frame according to the motion vector.

In this embodiment, the motion vector of the original input code stream corresponding to the position macroblock is used to perform the motion estimation for the current coded macroblock such that it is able to reduce a large amount of time for encoding and confine the actual encoding motion search window within a smaller region to improve the efficiency of the motion estimation.

### 4^{th} Embodiment

FIG. 4 is a technique flow chart of another embodiment of the disclosure. The embodiment provides a specific example for encoding the bidirectional predictive encoded frame according to the method of real-time transcoding for inheritance of encoding information, and the example is achieved by the following steps:

step 410: prohibiting two encoding modes B-16×8 and B-8×16, and enabling B-DIRECT mode by default;

the B-frame is similar to the P-frame but can support the following reference frame. Thus the mode selection is more complicated than the P-frame. In a practical test, the ratio of B-16×8 and B-8×16 is less than 5%, and it provides less contribution for saving data rate (testing sequence with different contents may cause different results, but usually will not exceed 5%) such that the two encoding modes B-16×8 and B-8×16 are prohibited in the transcoding system, and B-DIRECT mode is enabled by default.

Step 420: obtaining an original encoding mode corresponding to one macroblock having the same position as encoded macroblock in the bidirectional predictive encoded frame from the input code stream; and selecting the best encoding mode of the bidirectional predictive encoded frame according to the original encoding mode and B-DIRECT mode enabled by default.

When the original encoding mode is intra encoded macroblock, the current coded macroblock is encoded by the encoding strategy having same as the intra encoding module in the I-frame. The best intra predictive mode is selected to be compared with B-DIRECT mode, and the one having less cost is used as the final encoding mode;

when the original encoding mode is B-SKIP or B-DIRECT, the current encoded macroblock only performs the predetermination of B-DIRECT and the mode decision of ref0 in B-16×16, and the one having less cost is used as the final encoding mode;

when the original encoding mode is B-16×16, the current encoded macroblock only performs the predetermination of B-DIRECT and the mode decision of B-16×16, the reference frame corresponding to the position block is considered as a possible frame, and the one having less cost is used as the final encoding mode;

when the original encoding mode is B-8×8, the current encoded macroblock only performs the predetermination of B-DIRECT and the mode decision of B-8×8, the reference frame corresponding to the position block is considered as the possible frame, and the one having less cost is used as the final encoding mode;

in this embodiment, by obtaining the original encoding mode corresponding to the macroblock having the same position as encoded macroblock in the bidirectional predictive encoded frame, the encoding mode of current encoded macroblock is predicted, thereby reducing the amount of time for transcoding while keeping higher video output quality.

### 5^{th} Embodiment

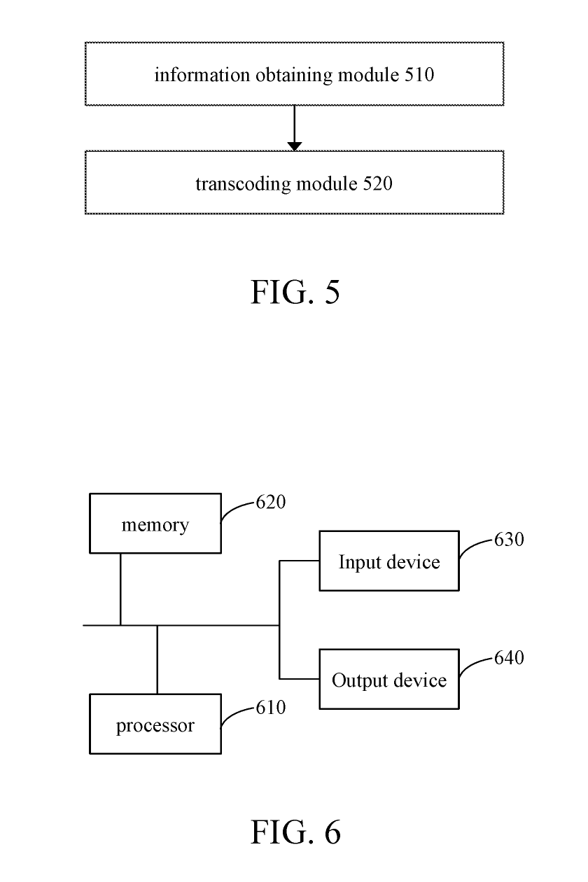

FIG. 5 is a schematic view of a device of another embodiment of the disclosure. The embodiment of the disclosure provides a device for executing real-time transcoding for inheritance of encoding information, and the device mainly includes two modules: an information obtaining module 510 and a transcoding module 520.

The information obtaining module 510 is adapted for decoding an input code stream and obtaining a code stream information during process of decoding, wherein the code stream information comprises frame type and macroblock encoding information of a decoding frame;

the transcoding module 520 is adapted for predicting frame type and macroblock encoding information of a transcoded frame corresponding to the input code stream according to the code stream information, and transcoding the input code stream.

Specifically, the transcoding module 520 is adapted for taking a frame type corresponding to the input code stream as the frame type of the decoding frame if a video encoding format is H.264, wherein the frame type comprises an intra predictive encoded frame, a previous predictive encoded frame or a bidirectional predictive encoded frame.

Specifically, the transcoding module 520 is further adapted for pre-calculating an encoding cost of 8×8 block mode when encoding an intra encoded macroblock in the intra predictive encoded frame; obtaining an original block mode corresponding to macroblock having the same position as the intra encoded macroblock in the intra predictive encoded frame from the input code stream; and selecting encoding mode of the intra encoded macroblock according to the original block mode and the encoding cost;

when encoding the previous predictive encoded frame, obtaining an original encoding mode corresponding to macroblock having the same position as encoded macroblock in the previous predictive encoded frame from the input code stream; obtaining a motion vector according to motion estimation of the original encoding mode; and performing motion compensation predictive encoding for the previous predictive encoded frame according to the motion vector;

when encoding the bidirectional predictive encoded frame, obtaining an original encoding mode corresponding to macroblock having the same position as the encoded macroblock in the bidirectional predictive encoded frame from the input code stream; and selecting best encoding mode of the bidirectional predictive encoded frame according to the original encoding mode and B-DIRECT mode which is enabled by default.

Specifically, the transcoding module 520 is further adapted for marking the type of a repeated frame as the previous predictive encoded frame, if the frame rate is changed during the process of transcoding to cause the repeated frame, and using SKIP encoding mode to encode default macroblock in the repeated frame.

The device shown in FIG. 5 can implement the method illustrated in the embodiments of FIGS. 1-4. Enabled theory and technical effect can be referred to the embodiments of FIGS. 1-4, and such illustration is omitted hereafter.

The device described above embodiments are merely exemplary, and wherein said means separating member as described may or may not be physically separated, as part of the display unit may be or may not be physical units, That may be at one place, or it can be distributed to multiple network elements. You can select part or all of the modules to achieve the purpose of implementation of the program according to the embodiment of the actual needs. Those of ordinary skill in the case without paying any creative work that can be understood and implemented.

### 6^{th} Embodiment

Another embodiment is the present disclosure provides a non-volatile computer storage medium. The computer storage medium stores computer-executable instructions, and the computer-executable instructions can carry out the method of real-time transcoding for inheritance of encoding information in any one of the embodiments.

### 7^{th} Embodiment

FIG. 6 is a schematic view of an electronic apparatus of another embodiment of the present disclosure. In this embodiment of the disclosure, an electronic apparatus for executing real-time transcoding for inheritance of encoding information is provided. As shown in FIG. 6, the electronic apparatus mainly includes:

one or more processors 610 and a memory 620, and the processor 610 is one in quantity in FIG. 6.

The electronic apparatus for executing real-time transcoding for inheritance of encoding information can include: an input device 630 and an output device 640.

The processor 610, the memory 620, the input device 630 and the output device 640 can be connected to each other via a bus or other members for electrical connection. In FIG. 5, they are connected to each other via the bus in this embodiment.

The memory 620 is one kind of non-volatile computer-readable storage mediums applicable to store non-volatile software programs, non-volatile computer-executable programs and modules; for example, the program instructions and the function modules (the information obtaining module 510 and the transcoding module 520 in FIG. 5) is stored in the memory 620. The processor 610 executes function applications and data processing of the server by running the non-volatile software programs, the non-volatile computer-executable programs and modules stored in the memory 620, and thereby the methods for controlling data rate of motion video in the aforementioned embodiments are achievable.

The memory 620 can include a program storage area and a data storage area, wherein the program storage area can store an operating system and at least one application program required for a function; the data storage area can store the data created according to the usage of the device for video switch. Furthermore, the memory 620 can include a high speed random-access memory, and further include a non-volatile memory such as at least one disk storage member, at least one flash memory member and other non-volatile solid state storage member. In some embodiments, the memory 620 can have a remote connection with the processor 610, and such memory can be connected to the device for controlling data rate of motion video by a network. The aforementioned network includes, but not limited to, internet, intranet, local area network, mobile communication network and combination thereof.

The input device 630 can receive digital or character information, and generate a key signal input corresponding to the user setting and the function control of the device for controlling data rate of motion video. The output device 640 can include a displaying unit such as screen.

The one or more modules are stored in the memory 620. When the modules are executed by the processor 610, the modules perform the method of real-time transcoding for inheritance of encoding information in any one of the embodiments.

The technical feature of the terminal apparatus, the function of each functional module and the relationships among the functional modules correspond to the embodiments. Any deficiencies in the illustration can be referred to the aforementioned embodiments.

The electronic apparatus in the embodiments of the present application is presence in many forms, and the electronic apparatus includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

The aforementioned embodiments are described for the purpose of explanation. The element for displaying can be a physical element or mot; that is, the element for displaying can be located on a specific position or distrusted among plural network units. Many modifications and variations are possible in view of part or all of the above teachings, to thereby enable others skilled in the art to best utilize the disclosure and various embodiments with various modifications as are suited to the particular use contemplated.

Through the above described embodiment, those skilled in the art can understand that the present disclosure may be implemented by software necessary hardware platform to achieve, of course, can all be implemented by hardware. Based on this understanding, the technical aspect of the present disclosure, background technology to contribute all or part may be embodied in the form of a software product, the computer software product may be stored in a storage medium, such as ROM/RAM, disk, CD-ROM, including several instructions to instruct a computer device (a personal computer, server, or network equipment) to perform various embodiments of the disclosure, or some portion of the method according to an embodiment.

Although described above with reference to FIG been described in accordance with various embodiments of the present disclosure, those skilled in the art would understand, the various embodiments of the present disclosure is made, may also departing from the present disclosure is not based on make a variety of improvements. Accordingly, the scope of the disclosure should be determined by the appended claims contents of the book claims.

What is claimed is:

1. A method of real-time transcoding for inheritance of encoding information, applied at a terminal, comprising:
decoding an input code stream and obtaining a code stream information during process of decoding, wherein the code stream information comprises frame type and macroblock encoding information of a decoding frame; and
predicting frame type and macroblock encoding information of a transcoded frame corresponding to the input code stream according to the code stream information, and transcoding the input code stream.

2. The method according to claim 1, wherein the transcoding the input code stream comprises:
taking a frame type corresponding to the input code stream as the frame type of the transcoded frame, if a video encoding format is H.264, wherein the frame type comprises an intra predictive encoded frame, a previous predictive encoded frame or a bidirectional predictive encoded frame.

3. The method according to claim 2, wherein the transcoding the input code stream comprises:
pre-calculating an encoding cost of 8×8 block mode, when encoding an intra encoded macroblock in the intra predictive encoded frame;
obtaining an original block mode corresponding to macroblock having the same position as the intra encoded macroblock in the intra predictive encoded frame from the input code stream; and
selecting encoding mode of the intra encoded macroblock according to the original block mode and the encoding cost.

4. The method according to claim 1, wherein the transcoding the input code stream comprises:
obtaining an original encoding mode corresponding to macroblock having the same position as encoded macroblock in the previous predictive encoded frame from the input code stream, when encoding the previous predictive encoded frame;
obtaining a motion vector according to motion estimation of the original encoding mode; and
performing motion compensation predictive encoding for the previous predictive encoded frame according to the motion vector.

5. The method according to claim 1, wherein the transcoding the input code stream comprises:
obtaining an original encoding mode corresponding to macroblock having the same position as encoded macroblock in the bidirectional predictive encoded frame from the input code stream, when encoding the bidirectional predictive encoded frame; and
selecting best encoding mode of the bidirectional predictive encoded frame according to the original encoding mode and B-DIRECT mode which is enabled by default.

6. The method according to claim 1, wherein the step of transcoding the input code stream comprises:
marking type of a repeated frame as the previous predictive encoded frame, if frame rate is changed during process of transcoding to cause the repeated frame, and using SKIP encoding mode to encode default macroblock in the repeated frame.

7. A non-volatile computer storage medium storing a computer-executable instruction, and the computer-executable instruction being for:
decoding an input code stream and obtaining a code stream information during process of decoding, wherein the code stream information comprises frame type and macroblock encoding information of a decoding frame; and
predicting frame type and macroblock encoding information of a transcoded frame corresponding to the input code stream according to the code stream information, and transcoding the input code stream.

8. An electronic apparatus, comprising:
at least one processor; and
a memory communicatively connected to the at least one processor, wherein the memory stores an instruction executable by the at least one processor, the at least one processor is for calling the instruction to execute a method comprising:
decoding an input code stream and obtaining a code stream information during process of decoding, wherein the code stream information comprises frame type and macroblock encoding information of a decoding frame; and
predicting frame type and macroblock encoding information of a transcoded frame corresponding to the input code stream according to the code stream information, and transcoding the input code stream.

9. The non-volatile computer storage medium according to claim 7, wherein the transcoding the input code stream further comprises:
taking a frame type corresponding to the input code stream as the frame type of the decoded frame, if a video encoding format is H.264, wherein the frame type comprises an intra predictive encoded frame, a previous predictive encoded frame or a bidirectional predictive encoded frame.

10. The non-volatile computer storage medium according to claim 9, wherein the transcoding the input code stream further comprises:
pre-calculating an encoding cost of 8×8 block mode, when encoding an intra encoded macroblock in the intra predictive encoded frame;
obtaining an original block mode corresponding to macroblock having the same position as the intra encoded macroblock in the intra predictive encoded frame from the input code stream; and
selecting encoding mode of the intra encoded macroblock according to the original block and the encoding cost.

11. The non-volatile computer storage medium according to claim 7, wherein the transcoding the input code stream further comprises:
obtaining an original encoding mode corresponding to macroblock having the same position as encoded macroblock in the previous predictive encoded frame from the input code stream, when encoding the previous predictive encoded frame;
obtaining a motion vector according to motion estimation of the original encoding mode; and
performing motion compensation predictive encoding for the previous predictive encoded frame according to the motion vector.

12. The non-volatile computer storage medium according to claim 7, wherein the transcoding the input code stream further comprises:
obtaining an original encoding mode corresponding to macroblock having the same position as encoded macroblock in the bidirectional predictive encoded frame from the input code stream, when encoding the bidirectional predictive encoded frame; and
selecting best encoding mode of the bidirectional predictive encoded frame according to the original encoding mode and B-DIRECT mode which is enabled by default.

13. The non-volatile computer storage medium according to claim 7, wherein the transcoding the input code stream further comprises:
marking type of a repeated frame as the previous predictive encoded frame, if frame rate is changed during process of transcoding to cause the repeated frame, and using SKIP encoding mode to encode default macroblock in the repeated frame.

14. The electronic apparatus according to claim 8, wherein the transcoding the input code stream further comprises:
taking a frame type corresponding to the input code stream as the frame type of the decoded frame, if a video encoding format is H.264, wherein the frame type comprises an intra predictive encoded frame, a previous predictive encoded frame or a bidirectional predictive encoded frame.

15. The electronic apparatus according to claim 14, wherein the transcoding the input code stream further comprises:
pre-calculating an encoding cost of 8×8 block mode, when encoding an intra encoded macroblock in the intra predictive encoded frame;
obtaining an original block mode corresponding to macroblock having the same position as the intra encoded macroblock in the intra predictive encoded frame from the input code stream; and
selecting encoding mode of the intra encoded macroblock according to the original block and the encoding cost.

16. The electronic apparatus according to claim 8, wherein the transcoding the input code stream further comprises:
obtaining an original encoding mode corresponding to macroblock having the same position as encoded macroblock in the previous predictive encoded frame from the input code stream, when encoding the previous predictive encoded frame;
obtaining a motion vector according to motion estimation of the original encoding mode; and
performing motion compensation predictive encoding for the previous predictive encoded frame according to the motion vector.

17. The electronic apparatus according to claim 8, wherein the transcoding the input code stream further comprises:
obtaining an original encoding mode corresponding to macroblock having the same position as encoded macroblock in the bidirectional predictive encoded frame from the input code stream, when encoding the bidirectional predictive encoded frame; and
selecting best encoding mode of the bidirectional predictive encoded frame according to the original encoding mode and B-DIRECT mode which is enabled by default.

18. The electronic apparatus according to claim 8, wherein the transcoding the input code stream further comprises:
marking type of a repeated frame as the previous predictive encoded frame, if frame rate is changed during process of transcoding to cause the repeated frame, and using SKIP encoding mode to encode default macroblock in the repeated frame.
